(19) United States
(12) Patent Application Publication
(10) Pub. No.: US 2024/0188580 A1
(43) Pub. Date: Jun. 13, 2024

(54) METHODS FOR MAKING A YOGURT PRODUCT

(71) Applicant: fairlife, LLC, Chicago, IL (US)

(72) Inventors: Kamil Piotr DRAPALA, Chicago, IL (US); Shakeel UR-REHMAN, Naperville, IL (US); Timothy Peter DOELMAN, Glencoe, IL (US)

(73) Assignee: fairlife, LLC, Chicago, IL (US)

(21) Appl. No.: 18/554,569

(22) PCT Filed: Apr. 27, 2022
(86) PCT No.: PCT/US2022/026569

§ 371 Date: Oct. 9, 2023

Related U.S. Application Data
(60) Provisional application No. 63/182,005, filed on Apr. 30, 2021.

(51) Int. Cl. A23C 9/142; A23C 9/12; A23C 9/123; B01D 61/02; B01D 61/14; B01D 61/58

(52) U.S. Cl. CPC A23C 9/1422; A23C 9/1206; A23C 9/123; B01D 61/026; B01D 61/0271; B01D 61/029; B01D 61/145; B01D 61/146; B01D 61/147; B01D 61/149; B01D 61/58; A23C 2210/202; A23C 2210/206; A23C 2210/252; B01D 2311/06; B01D 2311/08; B01D 2315/16

(57) ABSTRACT

Methods for converting cow's milk into a low pH, ready to drink yogurt product having the compositional attributes of human milk include combinations of ultrafiltration, nanofiltration, reverse osmosis, and diafiltration using microfiltration membranes, followed by heat treatment and fermentation.

### REFERENCE TO RELATED APPLICATION

This application is being filed on 27 Apr. 2022, as a PCT International patent application, and claims the benefit of and priority to U.S. Provisional Application Ser. No. 63/182,005, filed on Apr. 30, 2021, the disclosure of which is incorporated herein by reference in its entirety.

### BACKGROUND OF THE INVENTION

The present invention relates generally to the preparation of a yogurt product having the compositional attributes of human milk from cow's milk.

### SUMMARY OF THE INVENTION

This summary is provided to introduce a selection of concepts in a simplified form that are further described herein. This summary is not intended to identify required or essential features of the claimed subject matter. Nor is this summary intended to be used to limit the scope of the claimed subject matter.

Consistent with aspects of this invention, a first method for making a yogurt product having a weight ratio of whey protein to casein protein from 40:60 to 80:20 is disclosed herein, and the first method can comprise (i) ultrafiltering a milk product having a weight ratio of whey protein to casein protein from 15:85 to 25:75 to produce a UF permeate fraction and a UF retentate fraction, (ii) nanofiltering the UF permeate fraction to produce a first NF permeate fraction and a first NF retentate fraction, (iii) subjecting the first NF retentate fraction to a reverse osmosis step to produce a first RO permeate fraction and a first RO retentate fraction, (iv) diafiltering the UF retentate fraction through a microfiltration membrane to produce a MF/DF permeate fraction and a MF/DF retentate fraction, (v) nanofiltering the MF/DF permeate fraction to produce a second NF permeate fraction and a second NF retentate fraction, (vi) combining at least three of the second NF retentate fraction, the first RO permeate fraction, the first RO retentate fraction, skim milk, and a fat-rich fraction to form a dairy composition, (vii) heat treating the dairy composition, and (viii) inoculating the dairy composition with a yogurt culture and fermenting to produce the yogurt product having the weight ratio of whey protein to casein protein from 40:60 to 80:20.

A second method for making a yogurt product having a weight ratio of whey protein to casein protein from 40:60 to 80:20 also is disclosed herein, and the second method can comprise (i) ultrafiltering a milk product having a weight ratio of whey protein to casein protein from 15:85 to 25:75 to produce a first UF permeate fraction and a first UF retentate fraction, (ii) diafiltering the first UF retentate fraction through a microfiltration membrane to produce a MF/DF permeate fraction and a MF/DF retentate fraction, (iii) ultrafiltering the MF/DF permeate fraction to produce a second UF permeate fraction and a second UF retentate fraction, (iv) nanofiltering the first UF permeate fraction and/or the second UF permeate fraction to produce a NF permeate fraction and a NF retentate fraction, (v) subjecting the NF retentate fraction to a reverse osmosis step to produce a first RO permeate fraction and a first RO retentate fraction, (vi) subjecting the NF permeate fraction to a reverse osmosis step to produce a second RO permeate fraction and a second RO retentate fraction, (vii) combining at least three of the second UF retentate fraction, the first RO retentate fraction, the second RO retentate fraction, the first and/or the second RO permeate fraction, skim milk, and a fat-rich fraction to form a dairy composition, (viii) heat treating the dairy composition, and (ix) inoculating the dairy composition with a yogurt culture and fermenting to produce the yogurt product having the weight ratio of whey protein to casein protein from 40:60 to 80:20.

A third method for making a yogurt product having a weight ratio of whey protein to casein protein from 40:60 to 80:20 is provided in another aspect of this invention, and the third method can comprise (i) ultrafiltering a first milk product having a weight ratio of whey protein to casein protein from 15:85 to 25:75 to produce a first UF permeate fraction and a first UF retentate fraction, (ii) diafiltering a second milk product having a weight ratio of whey protein to casein protein from 15:85 to 25:75 through a microfiltration membrane to produce a MF/DF permeate fraction and a MF/DF retentate fraction, (iii) ultrafiltering the MF/DF permeate fraction to produce a second UF permeate fraction and a second UF retentate fraction, (iv) nanofiltering the first UF permeate fraction and/or the second UF permeate fraction to produce a first NF permeate fraction and a first NF retentate fraction, (v) subjecting the first NF retentate fraction to a reverse osmosis step to produce a first RO permeate fraction and a first RO retentate fraction, (vi) subjecting the first NF permeate fraction to a reverse osmosis step to produce a second RO permeate fraction and a second RO retentate fraction, (vii) combining at least three of the first and/or the second UF retentate fraction, the first RO retentate fraction, the second RO retentate fraction, the first and/or the second RO permeate fraction, and skim milk, to form a pre-mix composition, (viii) nanofiltering the pre-mix composition to form a second NF retentate fraction and a second NF permeate fraction, (ix) combining the second NF retentate fraction and the fat-rich fraction to form a dairy composition, (x) heat treating the dairy composition, and (xi) inoculating the dairy composition with a yogurt culture and fermenting to produce the yogurt product having the weight ratio of whey protein to casein protein from 40:60 to 80:20.

A fourth method for making a yogurt product having a weight ratio of whey protein to casein protein from 40:60 to 80:20 is provided in yet another aspect of this invention, and the fourth method can comprise (i) ultrafiltering a first milk product having a weight ratio of whey protein to casein protein from 15:85 to 25:75 to produce a first UF permeate fraction and a first UF retentate fraction, (ii) diafiltering the first UF retentate fraction through a microfiltration membrane to produce a MF/DF permeate fraction and a MF/DF retentate fraction, (iii) ultrafiltering the MF/DF permeate fraction to produce a second UF permeate fraction and a second UF retentate fraction, (iv) nanofiltering the first UF permeate fraction and/or the second UF permeate fraction to produce a first NF permeate fraction and a first NF retentate fraction, (v) nanofiltering the second UF retentate fraction to form a second NF retentate fraction and a second NF permeate fraction, (vi) subjecting the first NF retentate fraction to a reverse osmosis step to produce a first RO permeate fraction and a first RO retentate fraction, (vii) subjecting the first NF permeate fraction and/or the second NF permeate fraction to a reverse osmosis step to produce a second RO permeate fraction and a second RO retentate fraction, (viii) combining at least three of the first UF retentate fraction, the second NF retentate fraction, the first RO retentate fraction, the second RO retentate fraction, the first and/or the second RO permeate fraction, skim milk, and a fat-rich fraction to form a dairy composition, (ix) heat treating the dairy composition, and (x) inoculating the dairy composition with a yogurt culture and fermenting to produce the yogurt product having the weight ratio of whey protein to casein protein from 40:60 to 80:20.

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects can be directed to various feature combinations and sub-combinations described in the detailed description.

### BRIEF DESCRIPTION OF THE FIGURES

The following figures form part of the present specification and are included to further demonstrate certain aspects of the present invention. The invention may be better understood by reference to these figures in combination with the detailed description and examples.

FIG. 1 presents a schematic flow diagram of a first production process for a yogurt product, which is demonstrated in Example 1.

FIG. 2 presents a schematic flow diagram of a second production process for a yogurt product, which is demonstrated in Example 2.

FIG. 3 presents a schematic flow diagram of a third production process for a yogurt product, which is demonstrated in Example 3.

FIG. 4 presents a schematic flow diagram of a fourth production process for a yogurt product, which is demonstrated in Example 4.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997), can be applied, as long as that definition does not conflict with any other disclosure or definition applied herein, or render indefinite or non-enabled any claim to which that definition can be applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and/or feature disclosed herein, all combinations that do not detrimentally affect the designs, compositions, processes, and/or methods described herein are contemplated with or without explicit description of the particular combination. Additionally, unless explicitly recited otherwise, any aspect and/or feature disclosed herein can be combined to describe inventive designs, compositions, processes, and/or methods consistent with the present invention.

In this disclosure, while compositions and methods are often described in terms of “comprising” various components or steps, the compositions and methods also can “consist essentially of” or “consist of” the various components or steps, unless stated otherwise.

The terms “a,” “an,” and “the” are intended to include plural alternatives, e.g., at least one, unless otherwise specified. For instance, the disclosure of “an ingredient” is meant to encompass one or mixtures or combinations of more than one ingredient, unless otherwise specified.

In the disclosed methods, the terms “combining” and “inoculating” encompass the contacting of components in any order, in any manner, and for any length of time, unless otherwise specified. For example, the components can be blended or mixed.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. For example, the yogurt product can have a weight ratio of whey protein to casein protein in a range from 40:60 to 80:20 in aspects of this invention. By a disclosure that the weight ratio of whey protein to casein protein is from 40:60 to 80:20, the intent is to recite that the weight ratio can be any amount in the range and, for example, can include any range or combination of ranges from 40:60 to 80:20, such as from 50:50 to 75:25, from 60:40 to 75:25, from 65:35 to 75:25, from 60:40 to 72:28, or from 65:35 to 72:28. and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods, devices, and materials similar or equivalent to those described herein can be used in the practice or testing of the invention, the typical methods, devices, and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION OF THE INVENTION

Disclosed herein are integrated methods for starting with an animal milk product, such as cow's milk, and converting the starting milk product into a low pH (fermented and drinkable) yogurt product having the compositional attributes of human milk, in particular, the ratio of whey protein to casein protein. In the disclosed methods, the dairy composition, prior to fermentation, is subjected only to a mild heat treatment (e.g., pasteurization) step, such that there is minimal whey protein denaturation and/or nutrient degradation, and greater lysine availability.

Further, these methods overcome the challenges of recovering and concentrating sufficient lactose to form a suitable dairy composition, without the use of lactose powder, prior to fermentation. Typical lactose levels in the dairy composition prior to fermentation are 5-9 wt. %, or from 6-8 wt. %, although not limited thereto. For instance, the target lactose level of the dairy composition can be equivalent to that of human milk of around 7 wt. %, which is much different than cow's milk (e.g., 4-5 wt. % lactose).

These methods also overcome the challenges of recovering sufficient whey protein to form a dairy composition, without the use of whey protein isolate powder, that has the ratio of whey:casein protein of human milk, without resulting in other compositional attributes that are far removed from that of human milk, such as protein, fat, or mineral content (which is higher in cow's milk).

The fermented dairy yogurt products, produced as described herein, emulate the macronutrient composition of human milk, and are well suited for young children, such as from 6 months up to 3-4 years, although not limited thereto. In addition to containing live lactic acid bacteria, which promotes health and development of the immune system, additives such as galactooligosaccharides (GOS), which are a prebiotic and a source of dietary fiber, can be incorporated into the yogurt product. Often, during the mixing/combining step to form the dairy composition, GOS can be added an ingredient or a GOS-producing enzyme such as b-galactosidase (to produce GOS from lactose, glucose or galactose) can be added. Alternatively, the GOS-producing enzyme can be added during fermentation, or the GOS-producing enzyme can be added after fermentation and prior to filling/packaging.

### Methods of Making Yogurt Products

In accordance with an aspect of this invention, a first method for making a yogurt product having a weight ratio of whey protein to casein protein from 40:60 to 80:20 can comprise (or consist essentially of, or consist of) (i) ultrafiltering a milk product having a weight ratio of whey protein to casein protein from 15:85 to 25:75 to produce a UF permeate fraction and a UF retentate fraction, (ii) nanofiltering the UF permeate fraction to produce a first NF permeate fraction and a first NF retentate fraction, (iii) subjecting the first NF retentate fraction to a reverse osmosis step to produce a first RO permeate fraction and a first RO retentate fraction, (iv) diafiltering the UF retentate fraction through a microfiltration membrane to produce a MF/DF permeate fraction and a MF/DF retentate fraction, (v) nanofiltering the MF/DF permeate fraction to produce a second NF permeate fraction and a second NF retentate fraction, (vi) combining at least three of the second NF retentate fraction, the first RO permeate fraction, the first RO retentate fraction, skim milk, and a fat-rich fraction to form a dairy composition, (vii) heat treating the dairy composition, and (viii) inoculating the dairy composition with a yogurt culture and fermenting to produce the yogurt product having the weight ratio of whey protein to casein protein from 40:60 to 80:20.

In accordance with another aspect of this invention, a second method for making a yogurt product having a weight ratio of whey protein to casein protein from 40:60 to 80:20 can comprise (or consist essentially of, or consist of) (i) ultrafiltering a milk product having a weight ratio of whey protein to casein protein from 15:85 to 25:75 to produce a first UF permeate fraction and a first UF retentate fraction, (ii) diafiltering the first UF retentate fraction through a microfiltration membrane to produce a MF/DF permeate fraction and a MF/DF retentate fraction, (iii) ultrafiltering the MF/DF permeate fraction to produce a second UF permeate fraction and a second UF retentate fraction, (iv) nanofiltering the first UF permeate fraction and/or the second UF permeate fraction to produce a NF permeate fraction and a NF retentate fraction, (v) subjecting the NF retentate fraction to a reverse osmosis step to produce a first RO permeate fraction and a first RO retentate fraction, (vi) subjecting the NF permeate fraction to a reverse osmosis step to produce a second RO permeate fraction and a second RO retentate fraction, (vii) combining at least three of the second UF retentate fraction, the first RO retentate fraction, the second RO retentate fraction, the first and/or the second RO permeate fraction, skim milk, and a fat-rich fraction to form a dairy composition, (viii) heat treating the dairy composition, and (ix) inoculating the dairy composition with a yogurt culture and fermenting to produce the yogurt product having the weight ratio of whey protein to casein protein from 40:60 to 80:20.

In accordance with yet another aspect of this invention, a third method for making a yogurt product having a weight ratio of whey protein to casein protein from 40:60 to 80:20 can comprise (or consist essentially of, or consist of) (i) ultrafiltering a first milk product having a weight ratio of whey protein to casein protein from 15:85 to 25:75 to produce a first UF permeate fraction and a first UF retentate fraction, (ii) diafiltering a second milk product having a weight ratio of whey protein to casein protein from 15:85 to 25:75 through a microfiltration membrane to produce a MF/DF permeate fraction and a MF/DF retentate fraction, (iii) ultrafiltering the MF/DF permeate fraction to produce a second UF permeate fraction and a second UF retentate fraction, (iv) nanofiltering the first UF permeate fraction and/or the second UF permeate fraction to produce a first NF permeate fraction and a first NF retentate fraction, (v) subjecting the first NF retentate fraction to a reverse osmosis step to produce a first RO permeate fraction and a first RO retentate fraction, (vi) subjecting the first NF permeate fraction to a reverse osmosis step to produce a second RO permeate fraction and a second RO retentate fraction, (vii) combining at least three of the first and/or the second UF retentate fraction, the first RO retentate fraction, the second RO retentate fraction, the first and/or the second RO permeate fraction, and skim milk, to form a pre-mix composition, (viii) nanofiltering the pre-mix composition to form a second NF retentate fraction and a second NF permeate fraction, (ix) combining the second NF retentate fraction and the fat-rich fraction to form a dairy composition, (x) heat treating the dairy composition, and (xi) inoculating the dairy composition with a yogurt culture and fermenting to produce the yogurt product having the weight ratio of whey protein to casein protein from 40:60 to 80:20.

In accordance with still another aspect of this invention, a fourth method for making a yogurt product having a weight ratio of whey protein to casein protein from 40:60 to 80:20 can comprise (or consist essentially of, or consist of) (i) ultrafiltering a first milk product having a weight ratio of whey protein to casein protein from 15:85 to 25:75 to produce a first UF permeate fraction and a first UF retentate fraction, (ii) diafiltering the first UF retentate fraction through a microfiltration membrane to produce a MF/DF permeate fraction and a MF/DF retentate fraction, (iii) ultrafiltering the MF/DF permeate fraction to produce a second UF permeate fraction and a second UF retentate fraction, (iv) nanofiltering the first UF permeate fraction and/or the second UF permeate fraction to produce a first NF permeate fraction and a first NF retentate fraction, (v) nanofiltering the second UF retentate fraction to form a second NF retentate fraction and a second NF permeate fraction, (vi) subjecting the first NF retentate fraction to a reverse osmosis step to produce a first RO permeate fraction and a first RO retentate fraction, (vii) subjecting the first NF permeate fraction and/or the second NF permeate fraction to a reverse osmosis step to produce a second RO permeate fraction and a second RO retentate fraction, (viii) combining at least three of the first UF retentate fraction, the second NF retentate fraction, the first RO retentate fraction, the second RO retentate fraction, the first and/or the second RO permeate fraction, skim milk, and a fat-rich fraction to form a dairy composition, (ix) heat treating the dairy composition, and (x) inoculating the dairy composition with a yogurt culture and fermenting to produce the yogurt product having the weight ratio of whey protein to casein protein from 40:60 to 80:20.

Generally, the features of the first method, the second method, the third method, and the fourth method (e.g., the characteristics of the milk product, the characteristics of the dairy composition, the characteristics of the yogurt product, the weight ratios of whey:casein, the manner in which the ultrafiltration, nanofiltration, microfiltration, and reverse osmosis processes are performed, and the heat treatment conditions, among others) are independently described herein and these features can be combined in any combination to further describe the disclosed methods. Moreover, other process steps can be conducted before, during, and/or after any of the steps listed in the disclosed methods, unless stated otherwise. Additionally, any yogurt products (e.g., drinkable yogurt products, ready for consumption) produced in accordance with any of the disclosed methods are within the scope of this disclosure and are encompassed herein.

Filtration technologies (e.g., ultrafiltration, nanofiltration, diafiltration, etc.) can separate or concentrate components in mixtures—such as milk—by passing the mixture through a membrane system (or selective barrier) under suitable conditions (e.g., pressure). The concentration/separation can be, therefore, based on molecular size. The stream that is retained by the membrane is called the retentate (or concentrate). The stream that passes through the pores of the membrane is called the permeate. Referring now to first method, in step (i), a milk product is ultrafiltered to produce a UF permeate fraction and a UF retentate fraction. The milk product in step (i) can comprise (or consist essentially of, or consist of) skim milk, or alternatively, whole milk. In a particular aspect of this invention, the milk product comprises skim milk. Accordingly, the disclosed methods can further comprise a step of separating (e.g., centrifugally separating or microfiltering) a raw milk or fresh milk (whole milk) into the milk product (often, skim milk) and a fat-rich fraction (also referred to as cream or butter fat). The raw milk or fresh milk (whole milk) can be cow's milk, which contains approximately 87 wt. % water, 3-4 wt. % protein, 4-5 wt. % carbohydrates/lactose, 3-4 wt. % fat, and 0.3-0.8 wt. % minerals. The milk product, therefore, often has a weight ratio of whey protein to casein protein from 15:85 to 25:75, and in some aspects, from 16:84 to 24:76, from 17:83 to 23:77, or from 18:82 to 22:78.

When the fresh or raw milk product is separated into the skim milk product and the fat-rich fraction, the fat-rich fraction typically contains high levels of fat (e.g., 20-50 wt. % fat, 30-50 wt. %, 35-45 wt. % fat, or 38-42 wt. %) and solids (e.g., 30-60 wt. %, 40-55 wt. %, 40-50 wt. %, or 42-47 wt. %), and often contains approximately 1-4 wt. % protein (or 1-3 wt. %, or 2-3 wt. %), 2-5 wt. % lactose (or 2.5-4 wt. %, or 2.5-3.5 wt. %), and 0.2-0.9 wt. % minerals (or 0.2-0.6 wt. %, or 0.2-0.4 wt. %), although not limited thereto.

In contrast, the skim milk product typically contains very low levels of fat (e.g., less than or equal to 0.5 wt. %, less than or equal to 0.35 wt. 00 or less than or equal to 0.2 wt. %) and much lower solids (e.g., 7-13 wt. %, 8-12 wt. %, 8.5-10 wt. %, or 9-9.5 wt. %) than the fat-rich fraction, and often the skim milk product contains approximately 2-5 wt. % protein (or 3-4 wt. %, or 3.2-3.7 wt. %), 3-6 wt. % lactose (or 4-5.5 wt. %, or 4.5-5 wt. %), and 0.4-1.2 wt. % minerals (or 0.4-0.9 wt. %, or 0.5-0.9 wt. %), although not limited thereto.

In step (i), ultrafiltering of the milk product (e.g., skim milk with a weight ratio of whey protein to casein protein from 15:85 to 25:75) can be conducted using ultrafiltration membranes with pore sizes that typically are in the 0.01 to 0.1 micron range. In the dairy industry, the ultrafiltration membranes often are identified based on molecular weight cut-off (MWCO), rather than pore size. The molecular weight cut-off for ultrafiltration membranes can vary from 1000-100,000 Daltons, or from 10,000-100,000 Daltons. For instance, the milk product can be ultrafiltered using a polymeric membrane system (ceramic membranes also can be employed). The polymeric membrane system (or ceramic membrane system) can be configured with pore sizes such that the materials having molecular weights greater than 1,000 Daltons, greater than 5,000 Daltons, or greater than 10,000 Daltons, are retained, while lower molecular weight species pass through. For instance, UF membrane systems with a molecular weight cut-off of 10,000 Daltons can be used in the dairy industry for separating and concentrating milk proteins. In some aspects, the step of ultrafiltering utilizes a membrane system having pore sizes in a range from 0.01 to 0.1 μm, and operating pressures typically in the 15-150 psig range, or the 45-150 psig range. While not being limited thereto, the ultrafiltration step often can be conducted at a temperature in a range from 3 to 15° C., such as from 4 to 12° C., or from 5 to 10° C. Ultrafiltering at lower temperatures results in superior product quality and organoleptic properties as compared to higher temperature ultrafiltration (e.g., ˜25-50° C.), and further, a pasteurization step may not be needed if low temperature ultrafiltration is utilized.

In step (ii), the UF permeate fraction (some or all) can be subjected to a nanofiltration step to produce a first NF permeate fraction and a first NF retentate fraction. Nanofiltration in the dairy industry typically uses membrane elements that retain particles with molecular weights above approximately 100-300 Da, or 500-1000 Da. Nanofiltration is a pressure driven process in which the liquid is forced through a membrane under pressure, and materials having a molecular weight greater than the specified cut-off are retained, while smaller particles pass though the membrane pores. For generally separating lactose from minerals in an incoming stream, a pore size can be selected for maximum retention of lactose. Like ultrafiltration, nanofiltration can simultaneously perform both concentration and separation.

Nanofiltering can be conducted using nanofiltration membranes with pore sizes that typically are in the 0.001 to 0.01 micron range, for example, pore sizes in a range from 0.001 to 0.008 μm. In some aspects, the step of nanofiltration utilizes a membrane system having pore sizes in a range from 0.001 to 0.01 m, with operating pressures typically in the 150-600 psig range, and operating temperatures ranging from 10 to 60° C. (or from 15 to 45° C.), although not limited thereto.

In step (iii), the first NF retentate fraction (some or all) can be subjected to a reverse osmosis step to produce a first RO permeate fraction and a first RO retentate fraction. Reverse osmosis is a fine filtration process or concentration process in which substantially all the remaining milk components are retained (RO retentate), and only water (RO permeate, milk water) passes through. Often, reverse osmosis membrane systems have a molecular weight cutoff of much less than 100 Da and, therefore, components other than water are concentrated in the reverse osmosis process (e.g., minerals). Generally, reverse osmosis comprises a membrane system having pore sizes of less than or equal to 0.001 μm. Operating pressures typically are in the 450-1500 psig, or 450-600 psig, range. Temperatures ranging from 5 to 45° C., or from 15 to 45° C., often can used.

The UF retentate fraction—some or all of the UF retentate fraction produced in step (i)—can be subjected to diafiltration in step (iv) to produce a MF/DF permeate fraction and a MF/DF retentate fraction. Generally, the diafiltration step is performed using microfiltration membranes, as described herein. In one aspect, diafiltering the UF retentate fraction can comprise diafiltering a mixture of the UF retentate fraction and water. In another aspect, diafiltering the UF retentate fraction can comprise diafiltering a mixture of the UF retentate fraction and the first RO permeate fraction. In yet another aspect, diafiltering the UF retentate fraction can comprise diafiltering a mixture of the UF retentate fraction and any combination of water, the first RO permeate fraction, the first NF permeate fraction, and/or the second NF permeate fraction. These mixtures can utilize any suitable proportions or relative amounts of the UF retentate fraction and the water-rich fraction. Often, the diafiltration of the UF retentate fraction results in the MF/DF permeate fraction (which is rich in whey protein) and the MF/DF retentate fraction (which is rich in casein protein).

When the UF retentate fraction is mixed with (diluted with) another component (e.g., water) prior to introduction into the microfiltration membrane system, the weight ratio of the other component to the UF retentate fraction often ranges from 0.5:1 to 5:1, from 1:1 to 4:1, or from 1.5:1 to 3:1, but is not limited thereto. Additionally or alternatively, the solids content of the mixture of the UF retentate fraction and the other component (e.g., water) during diafiltration can range from 5 to 20 wt. % in one aspect, from 7 to 18 wt. % in another aspect, from 8 to 15 wt. % in another aspect, from 9 to 14 wt. % in yet another aspect, and from 10 to 12 wt. % in still another aspect. The diafiltration—using microfiltration membranes—can be conducted at any suitable concentration factor, non-limiting examples of which include from 1.2 to 5, from 1.3 to 4, from 1.2 to 3, or from 2 to 3.

Microfiltering can be conducted using microfiltration membranes with relatively large pore sizes that typically are in the 0.1 to 10 micron range, for example, pore sizes in a range from 0.2 to 2 μm, or from 0.1 to 0.2 μm. In some aspects, the step of microfiltering utilizes a membrane system having pore sizes in a range from 0.1 to 0.2 μm, with operating pressures typically less than 75 psig (e.g., 10-15 psig) and operating temperatures ranging from 5 to 60° C. (or from 35 to 55° C.), although not limited thereto.

The MF/DF permeate fraction is nanofiltered in step (v) of the first method to produce a second NF permeate fraction and a second NF retentate fraction. Optionally, the first method can further comprise a step of subjecting the first NF permeate fraction and/or the second NF permeate fraction to a reverse osmosis step to produce a second RO permeate fraction and a second RO retentate fraction. The second RO permeate fraction can be used in place of, or in combination with, the first RO permeate. For instance, the second RO permeate fraction can be utilized in step (iv), in which the UF retentate fraction is subject to diafiltration.

Step (vi) of the first method comprises combining at least three of the second NF retentate fraction, the first RO permeate fraction, the first RO retentate fraction, skim milk, and a fat-rich fraction to form a dairy composition. Any combinations of these components can be mixed or combined, in any suitable relative proportions, to form the dairy composition. In some aspects, at least the second NF retentate fraction, the first RO retentate fraction, and skim milk can be combined to form a dairy composition. If desired, the fat-rich fraction and/or the first RO permeate fraction (or water) also can be added in the combining step.

Moreover, an ingredient also can be added in the combining step. Additionally or alternatively, an ingredient can be added to the dairy composition after the combining step. Non-limiting examples of suitable ingredients can include a sugar/sweetener, a flavorant, a preservative (e.g., to prevent yeast or mold growth), a stabilizer, an emulsifier, a prebiotic substance, a probiotic bacteria, a vitamin, a mineral, an omega 3 fatty acid, a phyto-sterol, an antioxidant, or a colorant, and the like, as well as any mixture or combination thereof. If desired, lactase enzyme can be added to the milk product prior to ultrafiltration, or lactase enzyme can be added to each relevant component prior to the combining step, or lactase enzyme can be added during the combining step, or lactase enzyme can be added to the resultant dairy composition. In these circumstances, the lactose content can be reduced to less than 0.5 wt. %, and more often, less than 0.2 wt. %, or less than 0.1 wt. %.

Any suitable vessel and conditions can be used for any combining step disclosed herein, and such can be accomplished batchwise or continuously. As an example, the components can be combined in a suitable vessel (e.g., a tank, a silo, etc.) under atmospheric pressure, optionally with agitation or mixing, and optionally with an ingredient (or ingredients), to form a batch of the finished dairy composition. As another example, the components can be combined continuously in a pipe or other suitable vessel under slight pressure (e.g., 5-50 psig), optionally mixed with ingredients and the finished dairy composition can be transferred to a storage tank or other container(s).

The dairy composition in step (vi) can have a weight ratio of whey protein to casein protein similar to that of human milk, typically from 40:60 to 80:20. In one aspect, the weight ratio of whey protein to casein protein of the dairy composition can be from 50:50 to 75:25, while in another aspect, the weight ratio can be from 60:40 to 75:25, from 65:35 to 75:25 in another aspect, from 60:40 to 72:28 in yet another aspect, and from 65:35 to 72:28 in still another aspect. Although not limited thereof, the dairy composition often has a solids content of from 8 to 15 wt. % (or from 9 to 13 wt. % in another aspect, or from 11 to 12 wt. % in yet another aspect), and often contains from 1 to 3 wt. % protein (or from 1.5 to 2.5 wt. % in another aspect, or from 1.8 to 2.2 wt. % in yet another aspect), from 0.05 to 4 wt. % fat (or from 0.1 to 3 wt. % in another aspect, or from 0.2-2.5 wt. % in yet another aspect), from 4 to 10 wt. % lactose (or from 5 to 9 wt. % in another aspect, or from 6 to 8 wt. % in yet another aspect), and from 0.1 to 1 wt. % minerals (or from 0.2 to 0.7 wt. % in another aspect, or from 0.3 to 0.6 wt. % in yet another aspect).

Step (vii) is a step of heat treating the dairy composition. Generally, such heat treatment is performed at relatively mild conditions. Thus, UHT sterilization for 2+ sec is typically not employed. In contrast, the step of heat treating can comprise pasteurizing at a temperature in a range from 63° C. to 75° C. for a time period in a range from 5 sec to 45 min. In one aspect, the step of heating can comprise pasteurizing at a temperature of approximately 63° C. for 30 min, while in another aspect, the step of heat treating can comprise pasteurizing at a temperature of approximately 75° C. for 15 sec, and in yet another aspect, the step of heat treating can comprise pasteurizing at a temperature of 137-138° C. for 1 sec or less (e.g., 0.1 sec). Other appropriate pasteurization or sterilization temperature and time conditions that provide roughly the same heat load as pasteurization are readily apparent from this disclosure, and are encompassed herein. Further, this invention is not limited by the method or equipment used for performing the pasteurization/sterilization process—any suitable technique and apparatus can be employed, whether operated batchwise or continuously.

Beneficially, the mild heat treatment of the dairy composition prior to fermentation improves the nutritional quality of the yogurt product (e.g., better digestibility of protein) and offers nutrients in a state much closer to that found in human milk (e.g., less denatured protein and less Maillard reaction products). In contrast, in other nutrition products targeted for young children, the heat load is normally very severe, most often includes the steps of evaporation, spray drying, and UHT sterilization for 2+ sec, particularly, if a ready-to-drink product is the final composition.

In step (viii), the dairy composition—after heat treatment—can be inoculated (or combined) with a yogurt culture—any suitable yogurt culture(s)—and fermented to produce the yogurt product. The resultant yogurt product has a weight ratio of whey protein to casein protein from 40:60 to 80:20, such as from 50:50 to 75:25, from 60:40 to 75:25, from 65:35 to 75:25, from 60:40 to 72:28, or from 65:35 to 72:28, and the like. The yogurt product (e.g., a drinkable yogurt product) can have solids, protein, fat, and mineral contents that fall within the same ranges disclosed hereinabove for the dairy composition. Due to fermentation and the conversion of lactose to lactic acid, the yogurt product typically has a significantly reduced lactose content as compared to the dairy composition. Often, the lactose content of the yogurt product falls within a range from 1 to 6 wt. % in one aspect, from 2 to 5 wt. % in another aspect, from 2 to 4 wt. % in yet another aspect, and from 2.2 to 3.8 wt. % in still another aspect, although not limited thereto.

The dairy composition generally is inoculated and/or fermented at an elevated temperature. In one aspect, the dairy composition can be inoculated and/or fermented at a temperature in a range from 20 to 45° C., while in another aspect, the dairy composition can be inoculated and/or fermented at a temperature in a range from 35 to 45° C., and in yet another aspect, the dairy composition can be inoculated and/or fermented at a temperature in a range from 40 to 45° C. Other appropriate inoculation and/or fermentation temperatures are readily apparent from this disclosure.

The amount and type of the yogurt culture used can vary depending upon the desired attributes of the final yogurt product as well as the characteristics of the dairy composition. While not being limited thereto, the amount of the yogurt culture can range from 0.0001 to 3 wt. %, from 0.0005 to 0.05 wt. %, from 0.0001 to 0.01 wt. %, or from 0.0005 to 0.01 wt. %, based on the weight of the dairy composition.

The form of the yogurt culture is not particularly limited; the yogurt culture can be bulk, freeze dried, or frozen, and mixtures or combinations can be used as well. Typical yogurt cultures that can be used include, but are not limited to, Lactobacillus bulgaricus, Streptococcus thermophilus, Lactobacillus acidophillus, Lactobacillus casei, Lactococcus lactis, Lactococcus cremoris, Latobacillus plantarum, Bifidobacterium, Leuconostoc, and the like, as well as any combination thereof. In some aspects, the yogurt culture can comprise Lactobacillus bulgaricus, Streptococcus thermophilus, or a combination thereof.

As would be readily recognized by those of skill in the art, any suitable vessel can be used for forming the fermented yogurt product, and such can be accomplished batchwise or continuously. As an example, the fermentation step can be conducted in a tank, a silo, or a vat. Any suitable period of time can be used, and this can depend upon the temperature and the amount of the yogurt culture, amongst other variables. Generally, the inoculated dairy composition can be fermented for a time period in a range from 1 to 18 hours, from 2 to 8 hours, or from 3 to 7 hours. Typically, the inoculated dairy composition is fermented until the pH of the fermented product has reached a certain pH range. In some aspects, for example, the targeted pH can be in a range from 4.0 to 4.7, from 4.2 to 4.7, from 4.3 to 4.7, from 4.0 to 4.6, from 4.2 to 4.6, from 4.3 to 4.6, or from 4.5 to 4.6.

The methods disclosed herein can further comprise a step of packaging (aseptically or otherwise) the yogurt product in any suitable container and under any suitable conditions. Any suitable container can be used, such as might be used for the distribution and/or sale of yogurt or dairy items in a retail outlet. Illustrative and non-limiting examples of typical containers include a cup, a bottle, a bag, or a pouch, and the like. The container can be made from any suitable material, such as glass, metal, plastics, and the like, as well as combinations thereof.

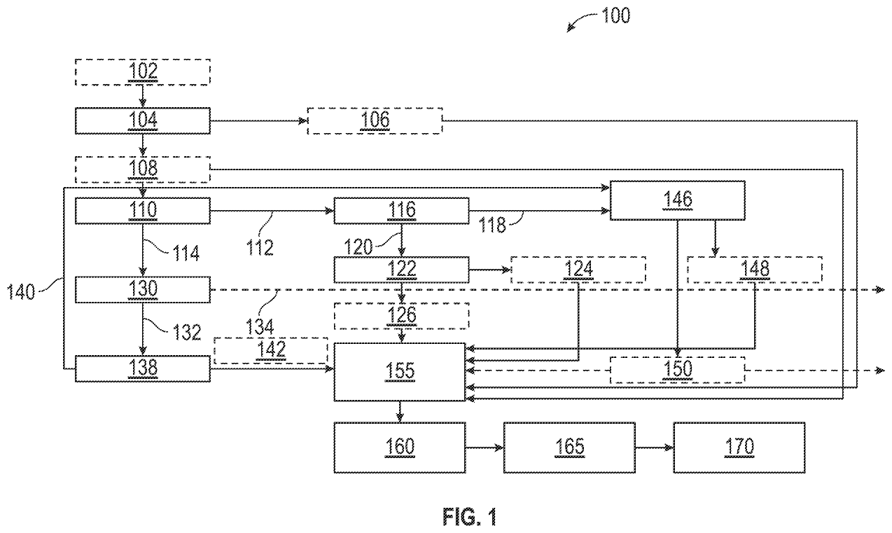

An illustrative and non-limiting example of a suitable separations process 100 consistent with aspects of the first method of this invention is shown in FIG. 1. First, fresh whole milk (raw milk) 102 is separated 104 into cream (or a fat-rich fraction) 106 and a skim milk product 108 using a suitable technique, such as centrifugal separation. The skim milk product 108 is then subjected to ultrafiltration 110, such as via a polymeric membrane system, as described herein, resulting in a UF retentate 114, often referred to as a protein-rich milk fraction, and a UF permeate 112 that contains lactose and minerals. The UF permeate 112 is then subjected to nanofiltration 116 to form a first NF permeate 118 and a first NF retentate 120, which is subjected to reverse osmosis 122 to form a first RO permeate 124 and a first RO retentate 126. The UF retentate 114 is diafiltered through a microfiltration membrane 130 to form a MF/DF permeate 132 and a MF/DF retentate 134. Next, the MF/DF permeate 132 is nanofiltered 138 to form a second NF permeate 140 and a second NF retentate 142. In FIG. 1, the first NF permeate 118 and/or the second NF permeate 140 is/are subjected to reverse osmosis 146 to form a second RO permeate 148 and a second RO retentate 150. While FIG. 1 shows two nanofiltration and two reverse osmosis units, this is not a requirement; a single nanofiltration unit and a single reverse osmosis unit can be used by appropriately sequencing the order of the nanofiltering and reverse osmosis steps.

The dairy composition in FIG. 1 is formed by combining or mixing 155—in any suitable proportions—the second NF retentate 142, the first RO permeate 124 (and/or the second RO permeate 148), the first RO retentate 126, skim milk 108, and cream 106 (fat-rich fraction). Subsequently, the dairy composition is heat treated 160 and then inoculated with a suitable yogurt culture and fermented 165 to produce the yogurt product, which is then filled or packaged 170 into suitable containers. Although not shown in the figures, after being heat treated, the dairy composition is cooled and the temperature adjusted to a suitable temperature prior to fermentation, often from approximately 45° F. on the low end to approximately 105° F. on the upper end, depending upon the specifics of the heat treatment and fermentation systems.

Referring now to the second method for making a yogurt product having a weight ratio of whey protein to casein protein from 40:60 to 80:20, this second method can comprise (or consist essentially of, or consist of) (i) ultrafiltering a milk product having a weight ratio of whey protein to casein protein from 15:85 to 25:75 to produce a first UF permeate fraction and a first UF retentate fraction, (ii) diafiltering the first UF retentate fraction through a microfiltration membrane to produce a MF/DF permeate fraction and a MF/DF retentate fraction, (iii) ultrafiltering the MF/DF permeate fraction to produce a second UF permeate fraction and a second UF retentate fraction, (iv) nanofiltering the first UF permeate fraction and/or the second UF permeate fraction to produce a NF permeate fraction and a NF retentate fraction, (v) subjecting the NF retentate fraction to a reverse osmosis step to produce a first RO permeate fraction and a first RO retentate fraction, (vi) subjecting the NF permeate fraction to a reverse osmosis step to produce a second RO permeate fraction and a second RO retentate fraction, (vii) combining at least three of the second UF retentate fraction, the first RO retentate fraction, the second RO retentate fraction, the first and/or the second RO permeate fraction, skim milk, and a fat-rich fraction to form a dairy composition, (viii) heat treating the dairy composition, and (ix) inoculating the dairy composition with a yogurt culture and fermenting to produce the yogurt product having the weight ratio of whey protein to casein protein from 40:60 to 80:20.

The properties or characteristics of the starting milk product (e.g., skim milk), the fat-rich fraction (cream), the produced dairy composition, and the final yogurt product in the second method can be the same as those described herein for the first method. Likewise, the ultrafiltering, nanofiltering, reverse osmosis, diafiltering, heat treating, inoculating and fermenting steps in the second method can be performed in a similar manner to the respective ultrafiltering, nanofiltering, reverse osmosis, diafiltering, heat treating, inoculating and fermenting steps in the first method. For instance, the first UF retentate fraction—some or all of the first UF retentate fraction produced in step (i)—can be subjected to diafiltration in step (ii) to produce a MF/DF permeate fraction and a MF/DF retentate fraction, using a microfiltration membrane, as described herein. Diafiltering the first UF retentate fraction can comprise diafiltering a mixture of the first UF retentate fraction and any combination of water, the first RO permeate fraction, and/or the second RO permeate fraction; the mixture can utilize any suitable proportions or relative amounts of the first UF retentate fraction and the water-rich fraction.

Combining step (vii) of the second method to form the dairy composition can be performed similarly to that of step (vi) of the first method, noting that step (vii) of the second method can comprise combining at least three of the second UF retentate fraction, the first RO retentate fraction, the second RO retentate fraction, the first and/or the second RO permeate fraction, skim milk, and the fat-rich fraction to form the dairy composition. Any combinations of these components can be mixed or combined, in any suitable relative proportions, to form the dairy composition. In some aspects, at least the second UF retentate fraction, the first RO retentate fraction, and skim milk can be combined to form the dairy composition. Moreover, an ingredient also can be added in the combining step of the second method, similar to the first method, and non-limiting examples of suitable ingredients can include a sugar/sweetener, a flavorant, a preservative (e.g., to prevent yeast or mold growth), a stabilizer, an emulsifier, a prebiotic substance, a probiotic bacteria, a vitamin, a mineral, an omega 3 fatty acid, a phyto-sterol, an antioxidant, or a colorant, and the like, as well as any mixture or combination thereof.

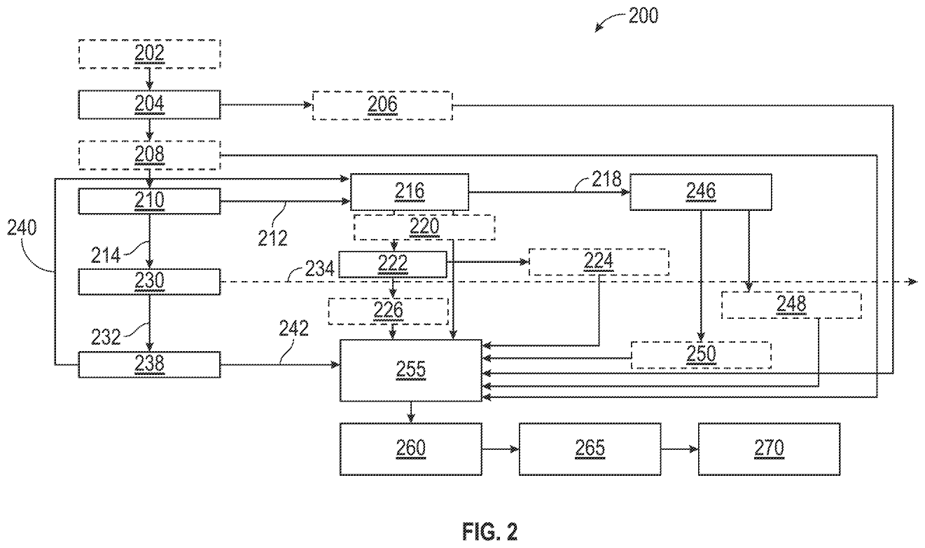

An illustrative and non-limiting example of a suitable separations process 200 consistent with aspects of the second method of this invention is shown in FIG. 2. First, fresh whole milk (raw milk) 202 is separated 204 into cream 206 (or a fat-rich fraction) and a skim milk product 208 using a suitable technique, such as centrifugal separation. The skim milk product 208 is then subjected to ultrafiltration 210, such as via a polymeric membrane system, as described herein, resulting in a first UF retentate 214, often referred to as a protein-rich milk fraction, and a first UF permeate 212 that contains lactose and minerals. The first UF retentate 214 is diafiltered through a microfiltration membrane 230 to form a MF/DF permeate 232 and a MF/DF retentate 234. Next, the MF/DF permeate 232 is ultrafiltered 238 to form a second UF permeate 240 and a second UF retentate 242. The first UF permeate 212 and/or the second UF permeate 240 is/are subjected to nanofiltration 216 to form a NF permeate 218 and a NF retentate 220, which is subjected to reverse osmosis 222 to form a first RO permeate 224 and a first RO retentate 226. The NF permeate 218 also is subjected to reverse osmosis 246 to form a second RO permeate 248 and a second RO retentate 250. While FIG. 2 shows two ultrafiltration and two reverse osmosis units, this is not a requirement; a single ultrafiltration unit and a single reverse osmosis unit can be used by appropriately sequencing the order of the ultrafiltering and reverse osmosis steps.

The dairy composition in FIG. 2 is formed by combining or mixing 255—in any suitable proportions—the second UF retentate 242, the first RO permeate 224 (and/or the second RO permeate 248), the first RO retentate 226, the second RO retentate 250, skim milk 208, and cream 206 (fat-rich fraction). Subsequently, the dairy composition is heat treated 260 and then inoculated with a suitable yogurt culture and fermented 265 to produce the yogurt product, which is then filled or packaged 270 into suitable containers.

Referring now to the third method for making a yogurt product having a weight ratio of whey protein to casein protein from 40:60 to 80:20, this third method can comprise (or consist essentially of, or consist of) (i) ultrafiltering a first milk product having a weight ratio of whey protein to casein protein from 15:85 to 25:75 to produce a first UF permeate fraction and a first UF retentate fraction, (ii) diafiltering a second milk product having a weight ratio of whey protein to casein protein from 15:85 to 25:75 through a microfiltration membrane to produce a MF/DF permeate fraction and a MF/DF retentate fraction, (iii) ultrafiltering the MF/DF permeate fraction to produce a second UF permeate fraction and a second UF retentate fraction, (iv) nanofiltering the first UF permeate fraction and/or the second UF permeate fraction to produce a first NF permeate fraction and a first NF retentate fraction, (v) subjecting the first NF retentate fraction to a reverse osmosis step to produce a first RO permeate fraction and a first RO retentate fraction, (vi) subjecting the first NF permeate fraction to a reverse osmosis step to produce a second RO permeate fraction and a second RO retentate fraction, (vii) combining at least three of the first and/or the second UF retentate fraction, the first RO retentate fraction, the second RO retentate fraction, the first and/or the second RO permeate fraction, and skim milk, to form a pre-mix composition, (viii) nanofiltering the pre-mix composition to form a second NF retentate fraction and a second NF permeate fraction, (ix) combining the second NF retentate fraction and the fat-rich fraction to form a dairy composition, (x) heat treating the dairy composition, and (xi) inoculating the dairy composition with a yogurt culture and fermenting to produce the yogurt product having the weight ratio of whey protein to casein protein from 40:60 to 80:20.

The properties or characteristics of the starting (first and second) milk product (e.g., skim milk), the fat-rich fraction (cream), the produced dairy composition, and the final yogurt product in the third method can be the same as those described herein for the first method. Likewise, the ultrafiltering, nanofiltering, reverse osmosis, diafiltering, heat treating, inoculating and fermenting steps in the third method can be performed in a similar manner to the respective ultrafiltering, nanofiltering, reverse osmosis, diafiltering, heat treating, inoculating and fermenting steps in the first method.

For instance, the second milk product can be subjected to diafiltration in step (ii) to produce a MF/DF permeate fraction and a MF/DF retentate fraction, using a microfiltration membrane, as described herein. Diafiltering the second milk product (e.g., skim milk) can comprise diafiltering a mixture of the second milk product and any combination of water, the first RO permeate fraction, and/or the second RO permeate fraction; the mixture can utilize any suitable proportions or relative amounts of the second milk product and the water-rich fraction.

Optionally, in the third method, a NF permeate mixture of the first NF permeate fraction and the second NF permeate fraction can be subjected to a reverse osmosis step to produce the second RO permeate fraction and the second RO retentate fraction.

Combining step (vii) of the third method to form the dairy composition can be performed similarly to that of step (vi) of the first method, noting that step (vii) of the third method can comprise combining at least three of the first UF retentate fraction, the second UF retentate fraction, the first RO retentate fraction, the second RO retentate fraction, the first and/or the second RO permeate fraction, and skim milk, to form the pre-mix composition. Any combinations of these components can be mixed or combined, in any suitable relative proportions, to form the pre-mix composition. In some aspects, at least the second UF retentate fraction, the first RO retentate fraction, and skim milk can be combined to form the pre-mix composition. Moreover, an ingredient also can be added in combining step (vii) of the third method, similar to the first method.

Thus, a pre-mix composition (effectively fat-free) is prepared in the third method by combining at least three of the first and/or the second UF retentate fraction, the first RO retentate fraction, the second RO retentate fraction, the first and/or the second RO permeate fraction, and skim milk. Next, in step (viii), the pre-mix composition is nanofiltered to form a second NF retentate fraction and a second NF permeate fraction. Subsequently, the second NF retentate fraction and the fat-rich fraction (and optional ingredients, if desired) are combined in step (ix) to form the dairy composition prior to heat treatment in step (x).

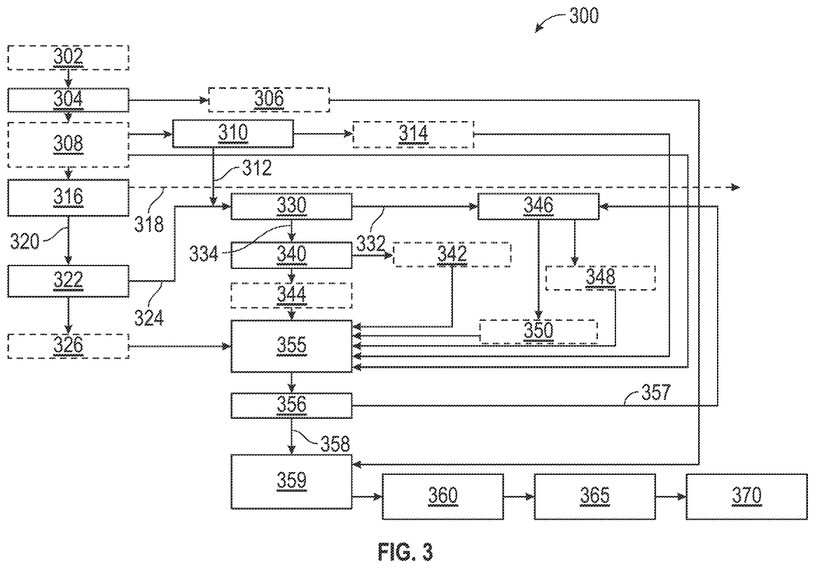

An illustrative and non-limiting example of a suitable separations process 300 consistent with aspects of the third method of this invention is shown in FIG. 3. First, fresh whole milk (raw milk) 302 is separated 304 into cream 306 (or a fat-rich fraction) and a skim milk product 308 using a suitable technique, such as centrifugal separation. Part of the skim milk product (a first milk product) is subjected to ultrafiltration 310, such as via a polymeric membrane system, as described herein, resulting in a first UF retentate 314, often referred to as a protein-rich milk fraction, and a first UF permeate 312 that contains lactose and minerals. Another part of the skim milk product (a second milk product) is diafiltered through a microfiltration membrane 316 to produce a MF/DF permeate 320 and a MF/DF retentate 318. While FIG. 3 shows the first milk product and the second milk product are the same composition, this is not a requirement.

The MF/DF permeate 320 is ultrafiltered 322 to form a second UF permeate 324 and a second UF retentate 326, and the first UF permeate 312 and/or the second UF permeate 324 is/are nanofiltered 330 to produce a first NF permeate 332 and a first NF retentate 334, which is subjected to reverse osmosis step 340 to produce a first RO permeate 342 and a first RO retentate 344. Likewise, the first NF permeate fraction 332 is subjected to reverse osmosis 346 to produce a second RO permeate 348 and a second RO retentate 350.

The pre-mix composition in FIG. 3 is formed by combining or mixing 355—in any suitable proportions—the first UF retentate 314 and/or the second UF retentate 326, the first RO retentate 344, the second RO retentate 350, the first RO permeate 342 and/or the second RO permeate 348, and skim milk 308. The pre-mix composition is nanofiltered 356 to form a second NF retentate 358 and a second NF permeate 357. While FIG. 3 shows two ultrafiltration, two nanofiltration, and two reverse osmosis units, this is not a requirement; a single ultrafiltration unit, a single nanofiltration unit, and a single reverse osmosis unit can be used by appropriately sequencing the order of the ultrafiltering, nanofiltering, and reverse osmosis steps.

The dairy composition in the third method is prepared by combining 359 the second NF retentate 358 and the fat-rich fraction 306 (cream). Subsequently, the dairy composition is heat treated 360 and then inoculated with a suitable yogurt culture and fermented 365 to produce the yogurt product, which is then filled or packaged 370 into suitable containers.

Referring now to the fourth method for making a yogurt product having a weight ratio of whey protein to casein protein from 40:60 to 80:20, this fourth method can comprise (or consist essentially of, or consist of) (i) ultrafiltering a first milk product having a weight ratio of whey protein to casein protein from 15:85 to 25:75 to produce a first UF permeate fraction and a first UF retentate fraction, (ii) diafiltering the first UF retentate fraction through a microfiltration membrane to produce a MF/DF permeate fraction and a MF/DF retentate fraction, (iii) ultrafiltering the MF/DF permeate fraction to produce a second UF permeate fraction and a second UF retentate fraction, (iv) nanofiltering the first UF permeate fraction and/or the second UF permeate fraction to produce a first NF permeate fraction and a first NF retentate fraction, (v) nanofiltering the second UF retentate fraction to form a second NF retentate fraction and a second NF permeate fraction, (vi) subjecting the first NF retentate fraction to a reverse osmosis step to produce a first RO permeate fraction and a first RO retentate fraction, (vii) subjecting the first NF permeate fraction and/or the second NF permeate fraction to a reverse osmosis step to produce a second RO permeate fraction and a second RO retentate fraction, (viii) combining at least three of the first UF retentate fraction, the second NF retentate fraction, the first RO retentate fraction, the second RO retentate fraction, the first and/or the second RO permeate fraction, skim milk, and a fat-rich fraction to form a dairy composition, (ix) heat treating the dairy composition, and (x) inoculating the dairy composition with a yogurt culture and fermenting to produce the yogurt product having the weight ratio of whey protein to casein protein from 40:60 to 80:20.

The properties or characteristics of the starting milk product (e.g., skim milk), the fat-rich fraction (cream), the produced dairy composition, and the final yogurt product in the fourth method can be the same as those described herein for the first method. Likewise, the ultrafiltering, nanofiltering, reverse osmosis, diafiltering, heat treating, inoculating and fermenting steps in the fourth method can be performed in a similar manner to the respective ultrafiltering, nanofiltering, reverse osmosis, diafiltering, heat treating, inoculating and fermenting steps in the first method. For instance, the first UF retentate fraction—some of the first UF retentate fraction produced in step (i)—can be subjected to diafiltration in step (ii) to produce a MF/DF permeate fraction and a MF/DF retentate fraction, using a microfiltration membrane, as described herein. Diafiltering the first UF retentate fraction can comprise diafiltering a mixture of the first UF retentate fraction and any combination of water, the first RO permeate fraction, and/or the second RO permeate fraction; the mixture can utilize any suitable proportions or relative amounts of the first UF retentate fraction and the water-rich fraction.

Combining step (viii) of the fourth method to form the dairy composition can be performed similarly to that of step (vi) of the first method, noting that step (viii) of the fourth method can comprise combining at least three of the first UF retentate fraction, the second NF retentate fraction, the first RO retentate fraction, the second RO retentate fraction, the first and/or the second RO permeate fraction, skim milk, and the fat-rich fraction to form the dairy composition. Any combinations of these components can be mixed or combined, in any suitable relative proportions, to form the dairy composition. In some aspects, at least the first UF retentate fraction, the second NF retentate fraction, and the first RO retentate fraction can be combined to form the dairy composition. Optionally, one or more ingredients also can be added during the combining step of the fourth method, similar to the first method.

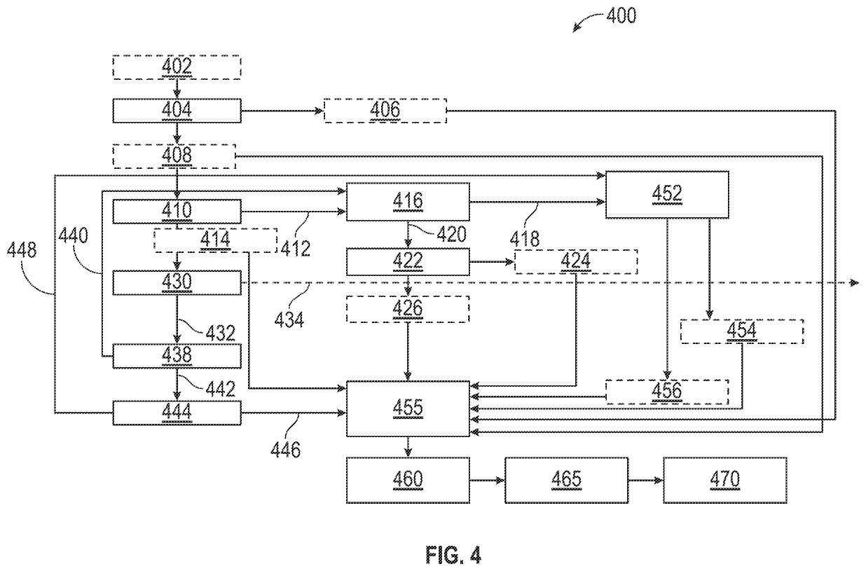

An illustrative and non-limiting example of a suitable separations process 400 consistent with aspects of the fourth method of this invention is shown in FIG. 4. First, fresh whole milk (raw milk) 402 is separated 404 into cream 406 (or a fat-rich fraction) and a skim milk product 408 using a suitable technique, such as centrifugal separation. The skim milk product 408 is then subjected to ultrafiltration 410, such as via a polymeric membrane system, as described herein, resulting in a first UF retentate 414, often referred to as a protein-rich milk fraction, and a first UF permeate 412 that contains lactose and minerals. In FIG. 4, a portion of the first UF retentate is diafiltered through a microfiltration membrane 430 to form a MF/DF permeate 432 and a MF/DF retentate 434. Next, the MF/DF permeate 432 is ultrafiltered 438 to form a second UF permeate 440 and a second UF retentate 442. The first UF permeate 412 and/or the second UF permeate 440 is/are subjected to nanofiltration 416 to form a first NF permeate 418 and a first NF retentate 420, and the second UF retentate 442 is subjected to nanofiltration 444 to form a second NF retentate 446 and a second NF permeate 448. The first NF retentate 420 is subjected to reverse osmosis 422 to produce a first RO permeate 424 and a first RO retentate 426, while the first NF permeate 418 and/or the second NF permeate 448 is/are subjected to reverse osmosis 452 to produce a second RO permeate 454 and a second RO retentate 456. While FIG. 4 shows two ultrafiltration, two nanofiltration, and two reverse osmosis units, this is not a requirement; a single ultrafiltration unit, a single nanofiltration unit, and a single reverse osmosis unit can be used by appropriately sequencing the order of the ultrafiltering, nanofiltering, and reverse osmosis steps.

The dairy composition in FIG. 4 is formed by combining or mixing 455—in any suitable proportions—the first UF retentate fraction 414, the second NF retentate fraction 446, the first RO retentate fraction 426, the second RO retentate fraction 456, the first RO permeate fraction 424 and/or the second RO permeate fraction 454, skim milk 408, and cream 406 (fat-rich fraction). Subsequently, the dairy composition is heat treated 460 and then inoculated with a suitable yogurt culture and fermented 465 to produce the yogurt product, which is then filled or packaged 470 into suitable containers.

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims.

Total solids (wt. %) were determined in accordance with procedure SMEDP 15.10 C by CEM Turbo Solids and Moisture Analyzer (CEM Corporation, Matthews, North Carolina). Ash is the residue remaining after ignition in a suitable apparatus at 550° C. to a constant weight; such treatment at 550° C. typically eliminates all organic matter, with the remaining material being primarily minerals (Standard Methods for the examination of dairy products, 17^{th} edition (2004), American Public Health Association, Washington DC). The ash test was performed by using a Phoenix (CEM Microwave Furnace), which heated the samples at 550° C. for 30 min. The mineral content (in wt. %) is generally similar to the ash content (wt. %), and thus the result of an ash test is used for quantification of the total mineral content in this disclosure. Protein content, fat content, and lactose content were determined by AOAC (Association of Official Analytical Chemists) methods.

The ratio of whey to casein (prior to heat treatment) was determined using pH 4.6 filtration method, which allows separation of non-denatured whey proteins from caseins. At the pH of 4.6 caseins precipitate, while whey proteins remain soluble. Lab filtration was used (filter paper Whatman 42, GE Healthcare Life Sciences; pore size/particle retention=2.5 μm). See Pizzano, R., Manzo, C., Adalgisa Nicolai, M., & Addeo, F. (2012), Occurrence of major whey proteins in the pH 4.6 insoluble protein fraction from UHT-treated milk, Journal of agricultural and food chemistry, 60(32), 8044-8050. Instead of using the above technique, for convenience, some ratios of whey to casein were calculated by mass balances and as described in Hurt, E., & Barbano, D. M. (2010), Processing factors that influence casein and serum protein separation by microfiltration, Journal of dairy science, 93(10), 4928-4941.

### EXAMPLE 1

FIG. 1 summarizes the process used in Example 1, and Table I summarizes the solids, protein (whey:casein), fat, mineral (ash), and lactose contents of the relevant process streams in FIG. 1. A milk separator was used to perform cold bowl mechanical separation of whole milk into a fat-rich fraction (cream) and skim milk by means of centrifugal forces at a temperature below 45° F. The cream was cooled to below 42° F., then transferred to a cold storage silo (36° F.). The skim milk was first passed through an ultrafiltration (UF) unit. The ultrafiltration unit employed membrane filters having a molecular exclusion range of ˜5,000-10,000 daltons. The UF membrane filters had a polysulfone/polypropylene support and a maximum pressure load of 150 psig. The skim milk was concentrated three-fold by single pass ultrafiltration to produce a UF retentate and a UF permeate; temperatures were kept below 45° F.

The UF permeate was concentrated three-fold to four-fold by nanofiltration unit 1 (NF Unit 1) to form a lactose-rich nanofiltration (NF) retentate (NF retentate 1) and a reduced-lactose NF permeate (NF permeate 1). The nanofiltration unit employed membrane filters having a molecular exclusion range of ˜100-1000 daltons and a maximum pressure load of 600 psig. The NF retentate 1 stream was concentrated two-fold to three-fold using a reverse osmosis (RO) unit (RO Unit 1) using membrane filters having a molecular exclusion range of ˜100-180 daltons. The RO filters were made of a thin film composite polyester material and were capable of sustaining a maximum pressure load of 550 psig. The RO retentate 1 and RO permeate 1 streams were stored in a cold room (below 45° F.) for future use, as described below.

The UF retentate was mixed with water filtered through activated carbon (alternatively, for example, RO permeate or NF permeate can be used instead of carbon-filtered water) at a weight ratio of 1:1.7-1:2.3. This dilution step is referred to as a diafiltration (DF) step, and its purpose was to maximize the removal of permeable constituents in the accompanying microfiltration process. The UF retentate/water mixture was filtered through microfiltration membranes having a molecular exclusion range of 10-200 kDa at pressures ranging from 15 to 45 psig. A proportion of the UF retentate was diluted to ˜8 wt. % total solids with filtered water prior to the start of microfiltration, and water and UF retentate were continuously being added to the balance tank on the filtration system to maintain the total solids content of 8-14 wt. % during filtration. The MF/DF permeate was stored below 45° F. until further use. Halfway into the filtration process, the MF/DF retentate was concentrated to between 12-18 wt. % total solids and stored below 45° F.

The MF/DF permeate was concentrated four-fold to five-fold by a nanofiltration step (NF Unit 2) to yield a fraction enriched in whey protein and lactose (NF retentate 2) and a dilute mineral water stream (NF permeate 2). The nanofiltration unit employed membrane filters having a molecular exclusion range of ˜100-1000 daltons and a maximum pressure load of 600 psig. In order to make a 30 kg batch of Dairy Composition 1A, 8 kg skim milk, 16 kg NF retentate 2, 2.3 kg RO retentate 1, 1.5 kg cream, 1.8 kg RO permeate 1 (or a mixture with RO permeate 2), and 0.45 kg of GOS syrup were blended together. A second dairy composition—Dairy Composition 1B—also was prepared by mixing these same ingredients in different proportions.

Dairy Composition 1A was heat treated at 137-138° C. for 6 sec (although lower temperature and shorter time pasteurization conditions preferably are used), homogenized, and cooled to be below 45° F. prior to use as the yogurt base for fermentation. The Dairy Composition 1A yogurt base was warmed up to 39° C. (102° F.) followed by addition of 0.005-0.007 wt. % of starter cultures (Lactobacillus delbrueckii subsp. bulgaricus and Streptococcus thermophilus) and 0.001-0.003 wt. % of probiotic cultures (Lactobacillus fermentum) pre-solubilized in small quantity of the yogurt base. The fermentation was allowed to progress for 5-6 hours, until the yogurt product reached a pH value of 4.3-4.6. After fermentation, the yogurt product was stored below 45° F. The yogurt product had effectively the same composition as that of Dairy Composition 1A, with the exception of lactose, a portion (e.g., approximately 50-80 wt. % of which can be consumed during fermentation), resulting in approximately 2.2 wt. % lactose. The ratio of whey:casein protein in the yogurt product was the same as in the dairy composition. However, heat treatment can affect the analytical result as it causes the whey protein to bind with caseins, which can result in overestimation of casein levels and underestimation of whey protein levels. To determine the ratio of whey:casein after heat treatment, the analytical method is sodium dodecyl sulfate polyacrylamide gel electrophoresis (SDS-PAGE), which is described in Jovanovic, S., Barac, M., Macej, O., Vucic, T., & Lacnjevac, C., (2007), SDS-PAGE analysis of soluble proteins in reconstituted milk exposed to different heat treatments, Sensors, 7(3), 371-383.

Beneficially, in the process of Example 1 as shown in Table I, the first RO retentate fraction had a very high lactose content (16-17 wt. %), and the recovery of whey protein in the MF/DF permeate fraction was greater than 90 wt. %, whereas MF alone often cannot recover more than 50-60 wt. % of the whey protein from the feed stream (UF retentate).

### EXAMPLE 2

FIG. 2 summarizes the process used in Example 2, and Table II summarizes the solids, protein (whey:casein), fat, mineral (ash), and lactose contents of the relevant process streams in FIG. 2. Example 2 was performed in substantially the same manner as Example 1, except as noted below.

In Example 2, the MF/DF permeate was concentrated four-fold to five-fold by an ultrafiltration step (UF Unit 2) to yield a fraction enriched in whey protein, but depleted in minerals (UF retentate 2) and a dilute mineral stream (UF permeate 2). The UF permeate 2 was further fractionated in the same manner as UF permeate 1 (treated like the UF permeate in Example 1). The ultrafiltration unit employed membrane filters having a molecular exclusion range of ˜5,000-10,000 daltons. The UF membrane filters had a polysulfone/polypropylene support and a maximum pressure load of 150 psig.

In order to make a 30 kg batch of Dairy Composition 2, 8.2 kg skim milk, 17.4 kg UF retentate 2, 2.2 kg RO retentate 1, 1.4 kg cream, 0.9 kg RO permeate 1 (or a mixture with RO permeate 2), and 0.44 kg of GOS syrup were blended together. Next, Dairy Composition 2 was heat treated, inoculated with yogurt culture, and fermented to produce a yogurt product, with the procedure similar to that described in Example 1.

Beneficially, in the process of Example 2 as shown in Table II, the ultrafiltration of the MF/DF permeate fraction produced a second UF retentate fraction with concentrated whey protein and a reduced/lower mineral content.

### EXAMPLE 3

FIG. 3 summarizes the process used in Example 3, and Table III summarizes the solids, protein (whey:casein), fat, mineral (ash), and lactose contents of the relevant process streams in FIG. 3. Example 3 was performed in substantially the same manner as Example 1, except as noted below.

In Example 3, skim milk was filtered through microfiltration membranes, where the molecular exclusion range ranged between 10-200 kDa at pressures ranging from 15 to 45 psig. The microfiltration step was carried out in a diafiltration mode (MF/DF Unit) as described in Example 1. Water and skim milk were continuously added to the balance tank on the filtration system to maintain the total solids content of 8-12 wt. % during filtration. The MF/DF permeate was concentrated four-fold to five-fold by ultrafiltration step (UF Unit 2) to yield a fraction enriched in whey protein and lactose (UF retentate 2) and a mineral water stream (UF permeate 2). The ultrafiltration unit employed membrane filters having a molecular exclusion range of ˜5,000-10,000 daltons. The UF membrane filters had a maximum pressure load of 150 psig.

Separately, skim milk also was fractionated by ultrafiltration (UF Unit 1) to yield UF retentate 1 and UF permeate 1, as described in Example 1, and UF permeate 1 was fractionated further by nanofiltration and reverse osmosis as described in Example 1.

In order to make a 276.7 kg batch of Dairy Composition 3A (pre-blend), 6.8 kg of UF Retentate 1 and 269.9 kg of UF Retentate 2 were blended together. This pre-blend composition was further concentrated two-fold to three-fold by nanofiltration (NF Unit 2) to yield a concentrated fat-free base (NF retentate 2). The nanofiltration unit employed membrane filters having a molecular exclusion range of −100-1000 daltons and a maximum pressure load of 600 psig.

Cream was blended with the concentrated fat-free base to yield the dairy composition 3B. In order to make a 30 kg batch, 1.4 kg cream and 0.44 kg of GOS syrup were blended with 28.2 kg of the pre-blend composition. Next, Dairy Composition 3B was heat treated, inoculated with yogurt culture, and fermented to produce a yogurt product, with the procedure similar to that described in Example 1.

Beneficially, in the process of Example 3 as shown in Table III, the pre-blend Dairy Composition 3A was very low in fat content and mineral content, and was mixed with cream (fat-rich fraction) prior to heat treatment and fermentation.

### EXAMPLE 4

FIG. 4 summarizes the process used in Example 4, and Table IV summarizes the solids, protein (whey:casein), fat, mineral (ash), and lactose contents of the relevant process streams in FIG. 4. Example 4 was performed in substantially the same manner as Example 1, except as noted below.

The UF retentate 1 stream (from UF Unit 1) was filtered through microfiltration membranes, where the molecular exclusion range ranged between 10-200 kDa at pressures ranging from 15 to 45 psig. The MF step was carried out in a diafiltration mode (MF/DF) as described in Example 1.

In Example 4, the MF/DF Permeate was concentrated two-fold to three-fold by ultrafiltration (UF Unit 2) to yield a fraction enriched in whey protein and depleted in lactose (UF retentate 2) and a lactose and mineral stream (UF permeate 2). The ultrafiltration unit employed membrane filters having a molecular exclusion range of ˜5,000-10,000 daltons. The UF membrane filters had a maximum pressure load of 150 psig.

The UF retentate 2 stream was further concentrated one-fold to three-fold by a nanofiltration (NF Unit 2) to yield a fraction enriched in whey protein with desired lactose and mineral contents (NF retentate 2) and a dilute mineral stream (NF permeate 2). The nanofiltration unit employed membrane filters having a molecular exclusion range of ˜100-1000 daltons and a maximum pressure load of 600 psig.

In order to make a 30 kg batch of Dairy Composition 4, 2.2 kg UF retentate 1, 17.3 kg NF retentate 2, 8.6 kg RO retentate 1, 1.4 kg cream, and 0.38 kg of GOS syrup were blended together. Next, Dairy Composition 4 was heat treated, inoculated with yogurt culture, and fermented to produce a yogurt product, with the procedure similar to that described in Example 1.

Beneficially, in the process of Example 4 as shown in Table IV, the sequential UF and NF treatment of the MF/DF permeate fraction produced the second NF retentate fraction with concentrated whey protein, but low mineral and lactose content.

TABLE I

| | Total solids | Protein | Whey:Casein | Fat | Minerals | Lactose | |
|---|---|---|---|---|---|---|---|
| Example 1 | (wt. %) | (wt. %) | Ratio | (wt. %) | (wt. %) | (wt. %) | pH |
| Skimmed milk | 9.16 | 3.39 | 21:79 | 0.15 | 0.66 | 4.96 | 6.74 |
| Cream | 46.75 | 2.50 | 21:79 | 41.13 | 0.35 | 2.77 | 6.68 |
| UF Retentate | 19.37 | 12.20 | 21:79 | 0.53 | 1.35 | 5.30 | 6.53 |
| MF/DF Permeate | 1.99 | 0.81 | 97:3 | 0 | 0.06 | 1.12 | 7.04 |
| MF/DF Retentate | 16.57 | 13.07 | 1:99 | 0.56 | 1.13 | 1.81 | 6.89 |
| NF Permeate 1 | 0.01 | 0 | — | 0 | 0.01 | 0 | 4.68 |
| NF Permeate 2 | 0.01 | 0 | — | 0 | 0.01 | 0 | 4.75 |
| NF Retentate 1 | 11.66 | 0.30 | — | 0.16 | 0.60 | 10.60 | — |
| NF Retentate 2 | 7.53 | 1.77 | 97:3 | 0.03 | 0.45 | 5.28 | 6.99 |
| RO Permeate 1 | 0 | 0 | — | 0 | 0 | 0 | — |
| RO Permeate 2 | 0 | 0 | — | 0 | 0 | 0 | — |
| RO Retentate 1 | 17.64 | 0.18 | — | 0 | 0.98 | 16.48 | 6.51 |
| RO Retentate 2 | 1.00 | 0 | — | 0 | 0.80 | 0.20 | 6.98 |
| Dairy Composition 1A | 11.71 | 2.01 | 72:28 | 2.15 | 0.51 | 7.04 | 6.83 |
| Dairy Composition 1B | 12.43 | 1.96 | 72:28 | 2.99 | 0.48 | 7.00 | 6.84 |

TABLE II

| | Total solids | Protein | Whey:Casein | Fat | Minerals | Lactose | |
|---|---|---|---|---|---|---|---|
| Example 2 | (wt. %) | (wt. %) | Ratio | (wt. %) | (wt. %) | (wt. %) | pH |
| Skimmed milk | 9.16 | 3.39 | 21:79 | 0.15 | 0.66 | 4.96 | 6.74 |
| Cream | 46.75 | 2.50 | 21:79 | 41.13 | 0.35 | 2.77 | 6.68 |
| UF Retentate 1 | 19.82 | 13.36 | 21:79 | 0.43 | 1.36 | 5.68 | 6.67 |
| UF Permeate 1 | 5.63 | 0.18 | — | 0.08 | 0.65 | 4.72 | — |
| MF/DF Permeate | 2.11 | 0.63 | 98:2 | 0 | 0.10 | 1.38 | 7.03 |
| MF/DF Retentate | 17.18 | 11.98 | 1:99 | 0.43 | 1.22 | 3.55 | 6.91 |
| UF Permeate 2 | 1.52 | 0.07 | 98:2 | 0 | 0.11 | 1.33 | 7.04 |
| UF Retentate 2 | 3.27 | 1.95 | 98:2 | 0 | 0.20 | 1.12 | 7.06 |
| NF Permeate | 0.01 | 0 | — | 0 | 0.01 | 0 | 4.90 |
| NF Retentate | 11.65 | 0.14 | — | 0 | 0.63 | 10.88 | 6.62 |
| RO Permeate 1 | 0 | 0 | — | 0 | 0 | 0 | — |
| RO Retentate 1 | 17.64 | 0.18 | — | 0 | 0.98 | 16.48 | 6.51 |
| RO Permeate 2 | 0 | 0 | — | 0 | 0 | 0 | — |
| RO Retentate 2 | 1.00 | 0 | — | 0 | 0.80 | 0.20 | 6.98 |
| Dairy Composition 2 | 10.91 | 1.86 | 72:28 | 2.14 | 0.32 | 6.59 | 6.78 |

TABLE III

| | Total solids | Protein | Whey:Casein | Fat | Minerals | Lactose | |
|---|---|---|---|---|---|---|---|
| Example 3 | (wt. %) | (wt. %) | Ratio | (wt. %) | (wt. %) | (wt. %) | pH |
| Skimmed milk | 9.16 | 3.39 | 21:79 | 0.15 | 0.66 | 4.96 | 6.74 |
| Cream | 46.75 | 2.50 | 21:79 | 41.13 | 0.35 | 2.77 | 6.68 |
| MF/DF Permeate | 3.42 | 0.38 | 98:2 | 0 | 0.28 | 2.76 | 6.68 |
| MF/DF Retentate | 13.11 | 11.43 | 1:99 | 0.64 | 0.69 | 0.35 | 7.03 |
| UF Permeate 1 | 5.63 | 0.18 | — | 0.08 | 0.65 | 4.72 | — |
| UF Retentate 1 | 20.83 | 13.36 | — | 0.43 | 1.36 | 5.68 | 6.67 |
| UF Permeate 2 | 2.98 | 0.07 | 98:2 | — | 0.13 | 2.78 | 6.65 |
| UF Retentate 2 | 3.53 | 0.43 | 98:2 | 0 | 0.30 | 2.80 | 6.70 |
| NF Permeate 1 | 0.01 | 0 | — | 0 | 0.01 | 0.00 | 4.87 |
| NF Retentate 1 | 11.84 | 0.09 | — | 0 | 0.66 | 11.09 | 6.57 |
| NF Permeate 2 | 0.28 | 0.04 | — | 0 | 0.14 | 0.10 | 6.95 |
| NF Retentate 2 | 10.39 | 2.02 | 50:50 | 0.04 | 0.63 | 7.70 | 6.82 |
| Dairy composition 3A | 12.13 | 2.01 | 50:50 | 2.01 | 0.61 | 7.50 | 6.82 |
| Dairy composition 3B | 13.08 | 2.01 | 50:50 | 3.08 | 0.60 | 7.39 | 6.76 |

TABLE IV

| | Total solids | Protein | Whey:Casein | Fat | Minerals | Lactose | |
|---|---|---|---|---|---|---|---|
| Example 4 | (wt. %) | (wt. %) | Ratio | (wt. %) | (wt. %) | (wt. %) | pH |
| Skimmed milk | 9.16 | 3.39 | 21:79 | 0.15 | 0.66 | 4.96 | 6.74 |
| Cream | 46.75 | 2.50 | 21:79 | 41.13 | 0.35 | 2.77 | 6.68 |
| UF Retentate 1 | 19.78 | 12.37 | 21:79 | 0.44 | 1.46 | 5.51 | 6.57 |
| UF Permeate 1 | 5.63 | 0.18 | — | 0.08 | 0.65 | 4.72 | — |
| MF/DF Permeate | 1.90 | 0.63 | 98:2 | 0 | 0.25 | 1.02 | 6.89 |
| MF/DF Retentate | 14.14 | 9.19 | 1:99 | 0.38 | 0.99 | 3.58 | 6.81 |
| UF Permeate 2 | 1.09 | 0.06 | — | 0 | 0.17 | 0.86 | 6.94 |
| UF Retentate 2 | 2.14 | 1.17 | 98:2 | 0 | 0.26 | 0.71 | 6.95 |
| NF Permeate 1 | 0.01 | 0 | — | 0 | 0.01 | 0 | 4.87 |
| NF Retentate 1 | 11.87 | 0.12 | — | 0 | 0.66 | 11.09 | 6.57 |
| NF Permeate 2 | 0.02 | 0 | — | 0 | — | 0 | 7.14 |
| NF Retentate 2 | 2.16 | 1.46 | 98:2 | 0 | 0.30 | 0.40 | 7.15 |
| RO Permeate 1 | 0 | 0 | — | 0 | 0 | 0 | — |
| RO Retentate 1 | 17.64 | 0.18 | — | 0 | 0.98 | 16.48 | 6.51 |
| RO Permeate 2 | 0 | 0 | — | 0 | 0 | 0 | — |
| RO Retentate 2 | 1.00 | 0 | — | 0 | 0.80 | 0.20 | 6.98 |
| Dairy composition 4 | 11.61 | 1.99 | 72:28 | 1.98 | 0.63 | 7.01 | 6.94 |

1. A method for making a yogurt product having a weight ratio of whey protein to casein protein from 40:60 to 80:20, the method comprising:
(i) ultrafiltering a milk product having a weight ratio of whey protein to casein protein from 15:85 to 25:75 to produce a UF permeate fraction and a UF retentate fraction;
(ii) nanofiltering the UF permeate fraction to produce a first NF permeate fraction and a first NF retentate fraction;
(iii) subjecting the first NF retentate fraction to a reverse osmosis step to produce a first RO permeate fraction and a first RO retentate fraction;
(iv) diafiltering the UF retentate fraction through a microfiltration membrane to produce a MF/DF permeate fraction and a MF/DF retentate fraction;
(v) nanofiltering the MF/DF permeate fraction to produce a second NF permeate fraction and a second NF retentate fraction;
(vi) combining at least three of the second NF retentate fraction, the first RO permeate fraction, the first RO retentate fraction, skim milk, and a fat-rich fraction to form a dairy composition;
(vii) heat treating the dairy composition; and
(viii) inoculating the dairy composition with a yogurt culture and fermenting to produce the yogurt product having the weight ratio of whey protein to casein protein from 40:60 to 80:20.

2. The method of claim 1, wherein diafiltering the UF retentate fraction through the microfiltration membrane comprises diafiltering a mixture of (1) the UF retentate fraction and (2) water, the first RO permeate fraction, the first NF permeate fraction, the second NF permeate fraction, or a combination thereof.

3. The method of claim 2, wherein the mixture has a solids content from 5 to 20 wt. %, from 7 to 18 wt. %, from 8 to 15 wt. %, from 9 to 14 wt. %, or from 10 to 12 wt. %.

4. The method of claim 1, further comprising a step of subjecting the first NF permeate fraction and/or the second NF permeate fraction to a reverse osmosis step to produce a second RO permeate fraction and a second RO retentate fraction.

5. The method of claim 4, wherein the second RO permeate fraction is combined in step (vi) to form the dairy composition.

6. A method for making a yogurt product having a weight ratio of whey protein to casein protein from 40:60 to 80:20, the method comprising:
(i) ultrafiltering a milk product having a weight ratio of whey protein to casein protein from 15:85 to 25:75 to produce a first UF permeate fraction and a first UF retentate fraction;
(ii) diafiltering the first UF retentate fraction through a microfiltration membrane to produce a MF/DF permeate fraction and a MF/DF retentate fraction;
(iii) ultrafiltering the MF/DF permeate fraction to produce a second UF permeate fraction and a second UF retentate fraction;
(iv) nanofiltering the first UF permeate fraction and/or the second UF permeate fraction to produce a NF permeate fraction and a NF retentate fraction;
(v) subjecting the NF retentate fraction to a reverse osmosis step to produce a first RO permeate fraction and a first RO retentate fraction;
(vi) subjecting the NF permeate fraction to a reverse osmosis step to produce a second RO permeate fraction and a second RO retentate fraction;
(vii) combining at least three of the second UF retentate fraction, the first RO retentate fraction, the second RO retentate fraction, the first and/or the second RO permeate fraction, skim milk, and a fat-rich fraction to form a dairy composition;
(viii) heat treating the dairy composition; and
(ix) inoculating the dairy composition with a yogurt culture and fermenting to produce the yogurt product having the weight ratio of whey protein to casein protein from 40:60 to 80:20.

7. The method of claim 6, wherein diafiltering the first UF retentate fraction through the microfiltration membrane comprises diafiltering a mixture of (1) the first UF retentate fraction and (2) water, the first RO permeate fraction, the second RO permeate fraction, or a combination thereof.

8. A method for making a yogurt product having a weight ratio of whey protein to casein protein from 40:60 to 80:20, the method comprising:
(i) ultrafiltering a milk product having a weight ratio of whey protein to casein protein from 15:85 to 25:75 to produce a first UF permeate fraction and a first UF retentate fraction;
(ii) diafiltering the first UF retentate fraction through a microfiltration membrane to produce a MF/DF permeate fraction and a MF/DF retentate fraction;
(iii) ultrafiltering the MF/DF permeate fraction to produce a second UF permeate fraction and a second UF retentate fraction;
(iv) nanofiltering the first UF permeate fraction and/or the second UF permeate fraction to produce a first NF permeate fraction and a first NF retentate fraction;
(v) nanofiltering the second UF retentate fraction to form a second NF retentate fraction and a second NF permeate fraction;
(vi) subjecting the first NF retentate fraction to a reverse osmosis step to produce a first RO permeate fraction and a first RO retentate fraction;
(vii) subjecting the first NF permeate fraction and/or the second NF permeate fraction to a reverse osmosis step to produce a second RO permeate fraction and a second RO retentate fraction;
(viii) combining at least three of the first UF retentate fraction, the second NF retentate fraction, the first RO retentate fraction, the second RO retentate fraction, the first and/or the second RO permeate fraction, skim milk, and a fat-rich fraction to form a dairy composition;
(ix) heat treating the dairy composition; and
(x) inoculating the dairy composition with a yogurt culture and fermenting to produce the yogurt product having the weight ratio of whey protein to casein protein from 40:60 to 80:20.

9. The method of claim 8, wherein diafiltering the first UF retentate fraction through the microfiltration membrane comprises diafiltering a mixture of (1) the first UF retentate fraction and (2) water, the first RO permeate fraction, the second RO permeate fraction, or a combination thereof.

10-12. (canceled)

13. The method of claim 1, wherein the milk product comprises skim milk.

14. The method of claim 13, wherein the skim milk contains:
from 7 to 13 wt. %, from 8 to 12 wt. %, from 8.5 to 10 wt. %, or from 9 to 9.5 wt. % solids;
less than or equal to 0.5 wt. %, less than or equal to 0.35 wt. %, or less than or equal to 0.2 wt. % fat;
from 2 to 5 wt. %, from 3 to 4 wt. %, or from 3.2 to 3.7 wt. % protein;
from 3 to 6 wt. %, from 4 to 5.5 wt. %, or from 4.5 to 5 wt. % lactose; and
from 0.4 to 1.2 wt. %, from 0.4 to 0.9 wt. %, or from 0.5 to 0.9 wt. % minerals.

15. (canceled)

16. The method of claim 1, wherein the fat-rich fraction contains:
from 30 to 60 wt. %, from 40 to 55 wt. %, from 40 to 50 wt. %, or from 42 to 47 wt. % solids;
from 20 to 50 wt. %, from 30 to 50 wt. %, from 35 to 45 wt. %, or from 38 to 42 wt. % fat;
from 1 to 4 wt. %, from 1 to 3 wt. %, or from 2 to 3 wt. % protein;
from 2 to 5 wt. % from 2.5 to 4 wt. %, or from 2.5 to 3.5 wt. % lactose; and
from 0.2 to 0.9 wt. %, from 0.2 to 0.6 wt. %, or from 0.2 to 0.4 wt. % minerals.

17. The method of claim 1, wherein the step of heat treating comprises pasteurizing at a temperature in a range from 63° C. to 75° C. for a time period in a range from 5 sec to 45 min.

18. The method of claim 1, wherein the combining step further comprises adding an ingredient, wherein the ingredient comprises a sugar/sweetener, a flavorant, a preservative, a stabilizer, an emulsifier, a prebiotic substance, a probiotic bacteria, a vitamin, a mineral, an omega 3 fatty acid, a phyto-sterol, an antioxidant, a colorant, or any combination thereof.

19. The method of claim 1, wherein the weight ratio of whey protein to casein protein of the milk product is from 16:84 to 24:76, from 17:83 to 23:77, or from 18:82 to 22:78.

20. The method of claim 1, wherein the weight ratio of whey protein to casein protein of the yogurt product is from 50:50 to 75:25, from 60:40 to 75:25, from 65:35 to 75:25, from 60:40 to 72:28, or from 65:35 to 72:28.

21. The method of claim 1, wherein the yogurt product contains:
from 8 to 15 wt. %, from 9 to 13 wt. %, or from 11 to 12 wt. % solids;
from 1 to 3 wt. %, from 1.5 to 2.5 wt. %, or from 1.8 to 2.2 wt. % protein;
from 0.05 to 4 wt. %, from 0.1 to 3 wt. %, or from 0.2 to 2.5 wt. % fat; and
from 0.1 to 1 wt. %, from 0.2 to 0.7 wt. %, or from 0.3 to 0.6 wt. % minerals.

22. The method of any one of claim 1, wherein:
the dairy composition contains from 4 to 10 wt. %, from 5 to 9 wt. %, or from 6 to 8 wt. % lactose; and/or
the yogurt product contains from 1 to 6 wt. %, from 2 to 5 wt. %, from 2 to 4 wt. %, or from 2.2 to 3.8 wt. % lactose.

23. The method of claim 1, further comprising a step of treating the dairy composition with lactase enzyme.

24. The method of claim 1, further comprising a step of packaging the yogurt product in a container.

25. (canceled)
